(19) United States
(12) Patent Application Publication
(10) Pub. No.: US 2009/0276746 A1
(43) Pub. Date: Nov. 5, 2009

(54) Circuit analysis method, semiconductor integrated circuit manufacturing method, circuit analysis program and circuit analyzer

(75) Inventor: Kouichi Nagai, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/385,993

(22) Filed: Apr. 27, 2009

(30) Foreign Application Priority Data
Apr. 30, 2008 (JP) 119342/2008

(51) Int. Cl. G06F 17/50

(52) U.S. Cl. 716/6

(57) ABSTRACT

To perform a timing analysis at a high analysis accuracy while reducing a TAT. A circuit analyzer according to the present invention performs a timing analysis on a design target circuit after a layout change. The circuit analyzer includes a storage device in which an extraction range reference is set, an extraction range setting unit and a timing analysis unit. The extraction setting unit sets the extraction range reference including a layout-changed portion, as a parasitic element extraction target range. The timing analysis unit performs a timing analysis by using, as an analysis target, a predetermined range including a parasitic element extracted from the extraction target range.

### BACKGROUND OF THE INVENTION

1. Field of the Invention

The present invention relates to a circuit analysis method, a semiconductor integrated circuit manufacturing method, a circuit analysis program and a circuit analyzer and, in particular, to a circuit analysis method, a circuit analysis program and a circuit analyzer for performing a timing analysis of a semiconductor integrated circuit after a layout change.

2. Description of the Related Art

A semiconductor integrated circuit undergoes layout changes until satisfying the timing constraint and the crosstalk constraint. Accordingly, every time the circuit layout is changed, a timing analysis including parasitic element extraction, delay time calculation, a crosstalk analysis and the like is performed to judge whether the circuit satisfies the constraints.

In recent years, the increasing scale of semiconductor integrated circuits has been requiring more complex designs and larger numbers of layout change positions and times. Consequently, the number of times that a timing analysis is performed after a layout change and the calculation amount for the analyses increase, which consequently causes turn around times (TATs) to be longer. In addition, it is concerned that a high integration density of interconnections and miniaturization in such a semiconductor integrated circuit may increase TATs of parasitic element extraction, delay time calculation and a crosstalk analysis.

Examples of a method for a timing analysis performed after a layout change are described in Japanese Patent Application Publication Nos. Hei 10-92938 (Patent Document 1, below) and Hei 11-282891 (Patent Document 2, below).

In the method described in Patent Document 1, a parasitic element at the coordinates at which a layout change has been made is extracted, and a delay time is recalculated only in relation to the parasitic element. Thus, the method described in Patent Document 1 achieves a reduction in a TAT of a timing analysis. This method, however, does not take account of effects of the pattern changed by the layout change on a peripheral portion thereof. For this reason, a timing analysis performed by this method has a lower accuracy in some cases. For example, in a timing analysis performed on the basis of a delay time obtained only in consideration of the layout-changed portion, the TAT is shortened while the analysis accuracy is low, compared with a full-chip analysis.

By contrast, in the method described in Patent Document 2, a delay time is calculated for both a portion at which a layout change has been made (referred to as a layout-changed portion or a changed portion, below) and portions whose delay times are affected by the layout change. Accordingly, an analysis using a shorter TAT than that used in a full-chip analysis and achieving a high accuracy at the same time can be performed.

In the method described in Patent Document 2, however, the portions whose delay times are affected by a layout change are specified in advance. Examples of such a portion are an interconnection connected to the layout-changed portion and a circuit element (logical element) directly connected to the layout-changed portion through the interconnection. Here, the layout-changed portion is a circuit element (logical element) or an interconnection changed by the layout change.

In the method described in Patent Document 2, a delay time is calculated by using the circuit element (logical element) or the interconnection changed by the layout change as the changed portion. In this case, only the circuit element or the interconnection at which the layout change has been made is extracted as the changed portion.

However, the delay time calculated after a layout change may also be affected by interconnections and circuit elements which are not directly connected to the changed circuit element. In other words, the delay time may also be affected by circuit elements and interconnections at which no layout change has been made. In the method described in Patent Document 2, such circuit elements and interconnections are not taken into account in the extraction of an element to be used for delay time calculation. For this reason, an analysis performed by using this method may have a lower accuracy than that achieved in a full-chip analysis. Here, a full-chip analysis is an analysis performed by taking account of all the circuit elements and interconnections including those at which no layout change has been made.

In view of the problems of the conventional techniques, a timing analysis method and an analyzer capable of performing a timing analysis using short TATs while maintaining an analysis accuracy to an equivalent level to that achieved in a full-chip analysis have been desired in the field of semiconductor integrated circuit design.

### SUMMARY

The present invention seeks to solve one or more of the above problems, or to improve upon those problems at least in part.

In one embodiment, a circuit analyzer (10) performs a timing analysis on a design target circuit after a layout change. The circuit analyzer (10) includes: a storage device (13) in which an extraction range reference (41) is set; an extraction range setting unit (1); and a timing analysis unit (2, 4, 6). The extraction range setting unit (1) sets the extraction range reference (41) including a layout-changed portion, as a parasitic element extraction target range (100). The timing analysis unit (2, 4, 6) performs a timing analysis by using, as an analysis target, a predetermined range (100, 200, 300) including a parasitic element (a1, a2) extracted from the extraction target range (100). On the basis of a result of the timing analysis performed by using the predetermined range (100, 200, 300) as the analysis target, the timing analysis unit (2, 4, 6) updates a timing analysis result of the design target circuit after the layout change, the timing analysis result recorded in the storage device (13).

As described above, the circuit analyzer (10) according to the present invention performs a timing analysis on the range including the parasitic element extracted from the range determined on the basis of the predetermined extraction reference (41) using the layout-changed portion as a reference. Accordingly, the circuit analyzer (10) according to the present invention can perform a timing analysis by taking account of the layout-changed portion and the peripheral portion thereof. Thus, according to the present invention, a highly accurate timing analysis can be performed. In addition, since the range on which a timing analysis is performed is narrowed down to the predetermined portion (100, 200, 300), the calculation amount required for the analysis is reduced, and a TAT is consequently shortened.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a configuration diagram showing a configuration of a circuit analyzer according to the present invention.

FIG. 2 is a functional block diagram showing a configuration of a circuit analysis program according to the present invention.

FIG. 3 is a block diagram showing configurations and operations of a parasitic element extraction tool, a delay time analysis tool and a crosstalk analysis tool according to the present invention.

FIG. 4 is a block diagram showing a configuration and operations of a layout tool according to the present invention.

FIG. 5 is a flowchart showing operations of layout change processing according to the present invention.

FIG. 6 is a flowchart showing details of operations of timing analysis processing performed in the layout change processing.

FIG. 7 is a schematic view of a layout showing an example of layout information updated by the layout change and an extraction target range set by the layout change.

FIG. 8 is a view showing an example including a part of design target circuit including a net corresponding to an extracted interconnection and a calculation target range set on the basis of the net as a reference element.

FIG. 9 is a view showing an example of the part of the design target circuit including the net shown in FIG. 8 and an analysis target range including the net, the range set on the basis of delay time recalculation information.

FIG. 10 is a view showing an example of the calculation target range and the analysis target range set by the circuit analyzer.

### DETAILED DESCRIPTION OF THE PREFERRED EMBODIMENT

An embodiment of a circuit analyzer according to the present invention will be described below with reference to the accompanying drawings.

(Outline)

A circuit analyzer 10 according to this embodiment generates a layout satisfying a given timing constraint and a given crosstalk constraint by performing layout changes and timing analyses on a semiconductor integrated circuit which is a design target (referred to as a design target circuit, below).

The circuit analyzer 10 performs a timing analysis by taking into account of a portion at which a layout change has been made (also referred to as a layout-changed portion or a changed portion, below) and peripheral portions of the layout-changed portion. Prior to the timing analysis, references for ranges on which the timing analysis is to be performed (analysis range references 24) are set, and target ranges of the timing analysis are determined in accordance with the layout-changed portion. Thereby, the circuit analyzer 10 performs the timing analysis only on the analysis target ranges including the layout-changed portion.

Specifically, the circuit analyzer 10 extracts, from a predetermined range which includes parasitic elements and at which the layout change has been made (an extraction target range 100), the parasitic elements, and then analyzes delay times of the interconnections corresponding to the extracted parasitic elements. In the analysis, a delay time is calculated by using circuit information on the circuit portions in each of predetermined ranges respectively including the interconnections corresponding to the extracted parasitic elements (calculation target ranges 200). Moreover, the circuit analyzer 10 tests the crosstalk of circuit portions in each range where the circuit portions operate at the same timing as the circuit portions in the corresponding calculation target range 200 (an analysis target range 300).

The circuit analyzer 10 reflects the analysis results in a timing analysis result for the entire design target circuit. The circuit analyzer 10 repeats a layout change and the above-described timing analysis until an updated timing analysis result satisfies the given constraints.

As described above, the circuit analyzer 10 according to this embodiment performs a timing analysis on an analysis target range determined by taking account of parasitic elements in a peripheral region of the layout-changed parasitic element. Hence, the circuit analyzer 10 is capable of maintaining high analysis accuracy while reducing a TAT.

(Configuration)

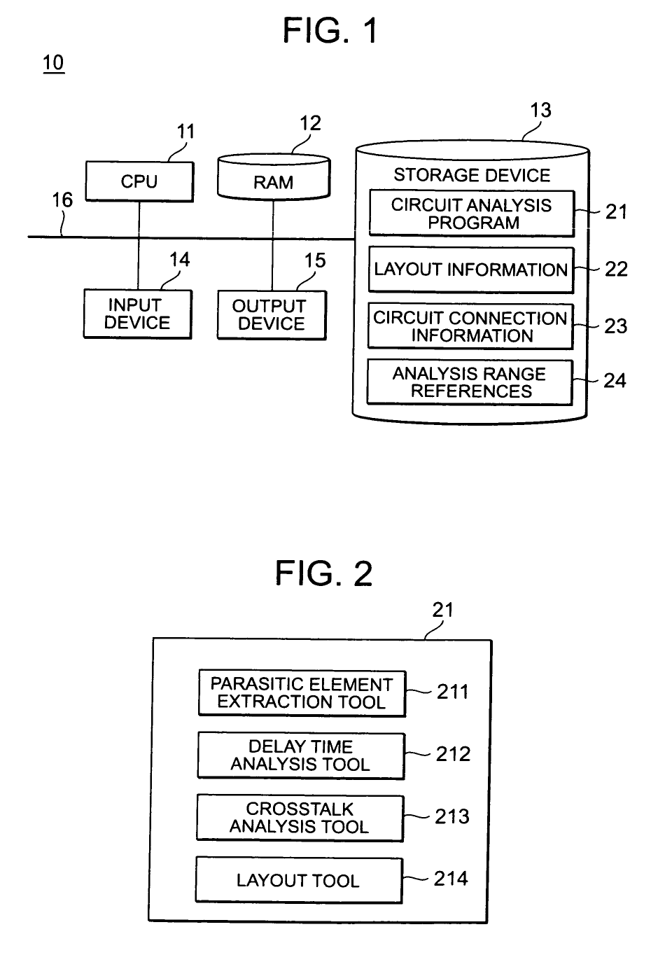

A configuration of the circuit analyzer 10 according to this embodiment of the present invention will be described with reference to FIGS. 1 to 4. FIG. 1 is a configuration diagram of the circuit analyzer 10 according to this embodiment. As shown in FIG. 1, the circuit analyzer 10 according to this embodiment includes a central processing unit (CPU) 11, a random-access memory (RAM) 12, a storage device 13, an input device 14 and an output device 15 which are connected to each other through a bus 16. The storage device 13 is an external storage device such as a hard disk or a memory. The input device 14 inputs various information pieces, instructions and the like to the CPU 11 in response to an operation of a mouse or a keyboard by a user. The output device 15, for example, a monitor or a printer, outputs a result of a circuit analysis outputted from the CPU 11, so that the user can see the result.

The storage device 13 stores a circuit analysis program 21, layout information 22, circuit connection information 23 and analysis range references 24. The layout information 22 includes arrangement information pieces (such as coordinate information pieces) on, for example: wiring elements of the analysis target circuit for which a layout has been made; and diffusion layers and wiring elements forming circuit elements (logical gates). The circuit connection information 23 includes connection information pieces on, for example, the circuit elements (logical gates) and circuit components (resistances, capacitances and inductances), in the analysis target circuit.

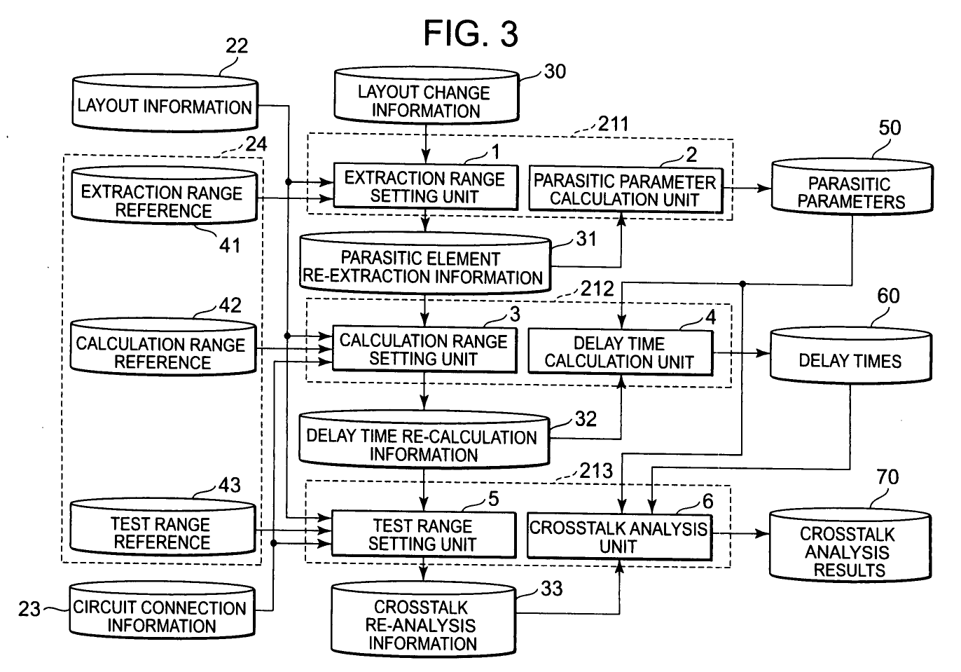

As shown in FIG. 3, the analysis range reference 24 includes an extraction range reference 41, a calculation range reference 42 and a test (analysis) range reference 43. The extraction range reference 41 is a reference for determining a range from which a parasitic element is to be extracted (referred to as an extraction target range 100, below) in the design target circuit after a layout change. In this embodiment, a predetermined distance (range) from a reference point is set as the extraction range reference 41. For the extraction of a parasitic element, a point on a layout-changed interconnection is specified as the reference point. In this case, a region in the range set as the extraction range reference 41 with the reference point as the base point is set as the extraction target range 100 from which the layout-changed parasitic element and parasitic parameters 50 (wiring capacitances (coupling capacitances), resistances and inductors) are extracted. As the extraction range reference 41, a range which affects the parasitic parameters of the interconnection at which a layout change (addition or shape change) has been made is preferably set.

In a full-chip analysis in which parasitic parameters (a wiring capacitance, for example) of a certain interconnection are accurately obtained, the capacitance between the certain interconnection and each of all the other interconnections needs to be calculated. However, when the wiring capacitance of an interconnection is calculated, approximate calculation is performed without taking account of capacitances with interconnections which are away from the certain interconnection by a certain distance (i.e., outside a neighboring range) by considering such capacitances sufficiently small. In other words, recalculation needs to be performed only in relation to the interconnections within the “certain distance” (neighboring range) from the layout-changed interconnection, in order to estimate the wiring capacitance of the certain interconnection at the same accuracy as that in the case of performing recalculation on all the interconnections. Thus, by employing approximate calculation, an analysis result as accurate as that obtained from a full-chip analysis can be obtained in shorter time. Such a calculation range used by a simulator is preferably set as the “analysis range reference” (recalculation range). To put it differently, the extraction range reference 41 set in the circuit analyzer 10 according to this embodiment is preferably set on the basis of the analysis accuracy (approximate calculation capability) of a parasitic element extraction tool 211 to be described later. With this configuration, parasitic parameters can be extracted at the same accuracy as that in the case of a full-chip analysis, in shorter time.

The calculation range reference 42 is a reference for determining a calculation target range (referred to as a calculation target range 200, below) on which calculation is to be performed to obtain a delay time of the design target circuit after a layout change. In this embodiment, the positions and the number of circuit elements and interconnections connected to the reference element are set as the calculation range reference 42. For example, for the calculation of a delay time, the net (interconnection) corresponding to each parasitic element extracted by the parasitic element extraction tool 211 is determined as the reference element. In this case, among a driver cell and interconnections connected to the input side of the net and a receiver cell and interconnections connected to the output side of the net, those satisfying the positions and the number specified by the calculation range reference 42 are set as the calculation target range 200.

In a high-speed simulator, to output an analysis result as accurate as that obtained by a full-chip analysis, in shorter time, delay time calculation is performed on narrowed-down ranges. In other words, approximate calculation is employed also in delay time calculation as in the parasitic element extraction simulation, thereby obtaining an analysis result as accurate as that obtained by a full-chip analysis, in shorter time. Accordingly, the calculation range reference 42 is preferably set on the basis of the analysis accuracy (approximate calculation capability) of a delay time analysis tool 212 to be described later.

The test range reference 43 is a reference for determining a range on (referred to as analysis target range 300, below) which crosstalk of the design target circuit after a layout change is to be tested. In this embodiment, a range including circuit portions operating at the same timing as each reference circuit portion is set as the test range reference 43. For example, for a crosstalk analysis, the circuit portions used for delay time calculation are set as the reference circuit portions. In this case, combinational circuit portions including a reference circuit portion and circuit portions operating at the same timing as the reference circuit portion is set as the analysis target range 300.

Crosstalk is tested on the basis of net operation timing, the parasitic parameters and the delay time (including waveform blunting). Here, the net operation timing is timing (operation time) at which the net signals operate from 0 to 1 or from 1 to 0. Accordingly, in the tool performing a high-speed simulation, approximate calculation of crosstalk is performed by setting a range in which the circuit portions operate at the same timing as the net operation timing as the analysis target range. Thereby, an analysis result as accurate as that obtained by a full-chip analysis can be obtained in shorter time. Accordingly, the test range reference 43 according to this embodiment is preferably set on the basis of the analysis accuracy (approximate calculation capability) of a crosstalk analysis tool 213 to be described later.

The CPU 11 executes the circuit analysis program 21 stored in the storage device 13, upon receipt of an input from the input device 14, to perform a layout change and a timing analysis of the design target circuit. In this event, various data and the program read from the storage device 13 are temporarily stored in the RAM 12, and the CPU 11 performs various processes by using the data stored in the RAM 12.

Instead of the configuration shown in FIG. 1, the circuit analyzer 10 may have a configuration including only a single computer having a multiprocessor system in which multiple CPUs are connected to each other with a bus.

FIG. 2 is a functional block diagram showing functions implemented in the circuit analyzer 10 according to this embodiment to perform a layout change and a timing analysis. As shown in FIG. 2, the CPU 11 implements functions as the parasitic element extraction tool 211, the delay time analysis tool 212, the crosstalk analysis tool 213 and the layout tool 214, by executing the circuit analysis program 21.

FIG. 3 is a block diagram showing configurations and operations of the parasitic element extraction tool 211, the delay time analysis tool 212 and the crosstalk analysis tool 213. With reference to FIG. 3, detailed configurations of the parasitic element extraction tool 211, the delay time analysis tool 212 and the crosstalk analysis tool 213 will be described.

The parasitic element extraction tool 211 determines the parasitic element extraction target range 100 by using the layout-changed interconnection as the reference point, and then extracts only the parasitic element changed by the layout change. In addition, the parasitic element extraction tool 211 calculates parasitic parameters by targeting the circuit portions in the extraction target range 100, and then updates parasitic parameters extracted before the layout change with the calculated parasitic parameters.

The parasitic element extraction tool 211 includes an extraction range setting unit 1 and a parasitic parameter calculation unit 2. The extraction range setting unit 1 sets the extraction target range 100 on the basis of the layout information 22, the layout change information 30 and the extraction range reference 41, and then outputs layout data on the circuit portions in the extraction target range 100 as parasitic element re-extraction information 31. Here, the layout change information 30 includes information on the position changed by the layout change (for example, coordinate information) and information for identifying changed circuit components. The extraction range setting unit 1 refers to the layout information 22 and the layout change information 30, identifies the coordinates of the interconnection changed (or added) by the layout change, and then designates the interconnection to be the reference point. On the basis of the designated reference point and the extraction range reference 41, the extraction range setting unit 1 sets the parasitic element extraction target range 100. The extraction target range 100 may include, in addition to the layout-changed interconnection, interconnections adjacent to the layout-changed interconnection. For this reason, the parasitic element re-extraction information 31 also includes information on, in addition to the layout-changed interconnection, other interconnections disposed in the extraction target range 100.

The parasitic parameter calculation unit 2 calculates the parasitic parameters 50 (resistances, wiring capacitances and inductors) of the interconnections included in the outputted parasitic element re-extraction information 31. Specifically, the parasitic parameter calculation unit 2 calculates the parasitic parameters 50 only of the interconnections in the predetermined range from the layout-changed interconnection (extraction target range 100). Then, the parasitic parameters recorded before the layout change are updated with the calculated parasitic parameters 50.

The delay time analysis tool 212 sets the delay time calculation target ranges 200 by using the interconnections included in the parasitic element re-extraction information 31 as the reference elements, and then calculates delay times.

The delay time analysis tool 212 includes a calculation range setting unit 3 and a delay time calculation unit 4. The calculation range setting unit 3 sets the delay time calculation target ranges 200 on the basis of the layout information 22, the circuit connection information 23, the calculation range reference 42 and the parasitic element re-extraction information 31, and then outputs the circuit portions in each of the calculation target ranges 200 (circuit connection information) as delay time re-calculation information 32. Specifically, the calculation range setting unit 3 designates nets corresponding to the interconnections included in the parasitic element re-extraction information 31 as the reference elements. Then, the calculation range setting unit 3 sets the calculation target range 200 on the basis of the reference elements and the calculation range reference 42, refers to the circuit connection information 23, and then extracts circuit connection information (instances and nets) on the circuit pieces in the calculation target range 200 as the delay time re-calculation information 32.

The delay time calculation unit 4 calculates a delay time 60 of the interconnections by using the delay time re-calculation information 32 and the wiring capacitances 50. The delay time re-calculation information 32 includes circuit portions (instances and nets) satisfying the conditions specified as the calculation range reference 42. By using the delay time re-calculation information 32, the delay time calculation unit 4 can calculate the delay times 60 by targeting only the circuit portions which include the interconnections extracted by the parasitic element extraction and which satisfy the calculation range reference 42. The delay times recorded before the layout change are updated with the calculated delay times 60.

Thus, the delay time analysis tool 212 calculates the delay times 60 by taking account of the interconnections disposed in the range within the predetermined distance from the layout-changed interconnection. Accordingly, more accurate delay times than those calculated by taking account only of the layout-changed interconnection can be obtained. In addition, since the delay time calculation target ranges 200 are each a limited range including an extracted interconnection, calculation time can be shorter than that in a full-chip analysis.

The crosstalk analysis tool 213 sets the crosstalk analysis target ranges 300 by using the delay time re-calculation information 32 as the reference circuit portions, and then performs a crosstalk analysis.

The crosstalk analysis tool 213 includes a test (analysis) range setting unit 5 and a crosstalk analysis unit 6. The test range setting unit 5 sets the analysis target ranges 300 on the basis of the layout information 22, the circuit connection information 23, the test range reference 43 and the delay time re-calculation information 32, and then outputs circuit portions in each of the analysis target range 300 (circuit connection information) as crosstalk re-analysis information 33. Specifically, the test range setting unit 5 designates the circuit portions (instances and nets) included in the delay time re-calculation information 32 as reference circuit portions. On the basis of the reference circuit portions and the test range reference 43, the test range setting unit 5 sets the analysis target ranges 300. The test range setting unit 5 refers to the circuit connection information 23, and then extracts circuit portions (instances and nets) in each of the analysis target ranges 300 as the crosstalk re-analysis information 33. The circuit portions included in the delay time re-calculation information 32 are those set by taking account of the interconnections disposed in the peripheral region of the layout-changed interconnection. Accordingly, the crosstalk analysis tool 213 outputs, as the crosstalk re-analysis information 33, the circuit portions (instances and nets) which include the circuit portions set by taking account of the interconnections disposed in the peripheral region of the layout-changed interconnection and which satisfy the conditions specified as the test range reference 43.

The crosstalk analysis unit 6 performs a crosstalk analysis by using the crosstalk re-analysis information 33, and then outputs the result as a crosstalk analysis result 70. Specifically, the crosstalk analysis unit 6 identifies analysis target circuit portions (paths) on the basis of the crosstalk re-analysis information 33, and then calculates crosstalk by targeting the analysis target paths only. Here, the crosstalk analysis unit 6 performs a crosstalk analysis only on the circuit portions (paths) which include the layout-changed interconnection and the peripheral interconnections and which satisfy the test range reference 43. The crosstalk analysis unit 6 performs a crosstalk analysis by using the wiring capacitance 50 and the delay time 60 calculated after the layout change. The crosstalk analysis results recorded before the layout change are updated with the crosstalk analysis results 70.

With the above-described configurations, the circuit analyzer 10 according to the embodiment of the present invention performs parasitic element extraction, parasitic parameter extraction, a delay time analysis and a crosstalk analysis again after a layout change by targeting only analysis target ranges determined on the basis of the layout-changed portion and the predetermined range references.

Here, the analysis range references 24 (the extraction range reference 41, the calculation range reference 42 and the test range reference 43) provided to the circuit analyzer 10 in advance are preferably set in accordance with the analysis accuracies of the analysis tools (the parasitic element extraction tool 211, the delay time analysis tool 212 and the crosstalk analysis tool 213), respectively. For example, to obtain the wiring capacitance of a certain interconnection, the capacitance between the certain interconnection and each of all the other interconnections needs to be calculated. However, since the capacitances with the interconnections each disposed away from the certain interconnection by a sufficient distance are small enough to be ignored, the wiring capacitance can be calculated only by taking account of the capacitances with the interconnections disposed within the predetermined distance (in a neighboring range). Thus, in general, to shorten time required for a calculation of a value (wiring capacitance) of a target portion by using a simulator performing an interconnection delay time analysis and wiring capacitance calculation, the value is calculated only by targeting a region within a predetermined distance from the target portion (approximate calculation) while omitting calculation for ignorable portions outside the region.

The parasitic element extraction tool 211, the delay time analysis tool 212 and the crosstalk analysis tool 213 according to this embodiment perform approximate calculations as in the conventional techniques. The analysis accuracy (approximate calculation capability) of each of the tools is set to be approximately equal to that achieved in a full-chip analysis. Hence, by setting the analysis range references 24 in accordance with the approximate calculation capabilities of the tools, an analysis result equivalent to that obtained in a full-chip analysis can be obtained. If each of the analysis range references 24 is set to include a larger range, the analysis accuracy may increase. However, the accuracy of an analysis cannot be higher than the analysis accuracy of any of the tools in any case, and such attempt only increases calculation time. Hence, to shorten TATs and improve the accuracy, each of the analysis range references 24 is preferably set in accordance with the analysis accuracy of the corresponding tool.

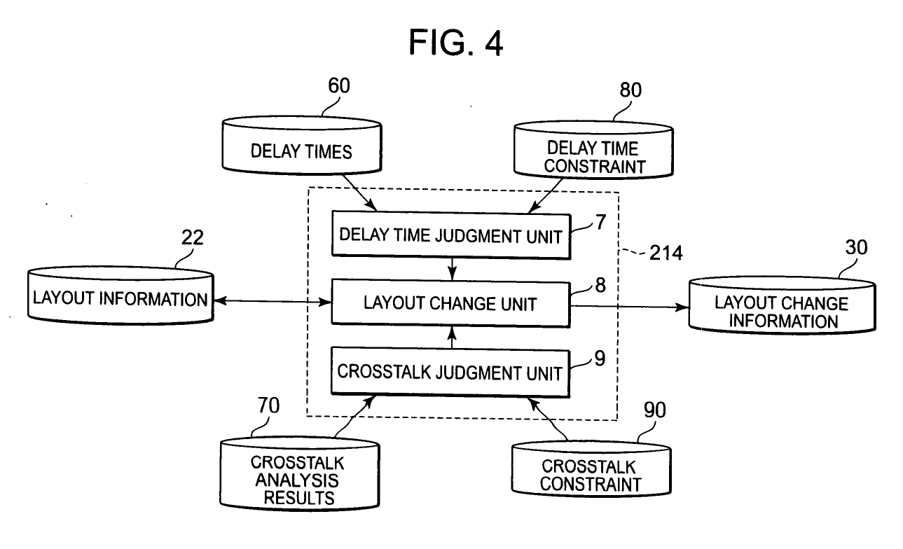

FIG. 4 is a block diagram showing a configuration and operations of the layout tool 214. As shown in FIG. 4, the layout tool 214 includes a delay time judgment unit 7, a layout change unit 8 and a crosstalk judgment unit 9. The delay time judgment unit 7 judges whether each of the delay times 60 calculated by the delay time analysis tool 212 satisfies a delay time constraint 80. The crosstalk judgment unit 9 judges whether each of the crosstalk analysis results 70 obtained by the crosstalk analysis tool 213 satisfies a crosstalk constraint 90. The layout change unit 8 identifies the layout-changed portion on the basis of the judgment results from the delay time judgment unit 7 and the crosstalk judgment unit 9, and then updates the layout information 22 with the identified portion. In this event, the layout change information 30 is updated with information for identifying the changed portion.

(Operations)

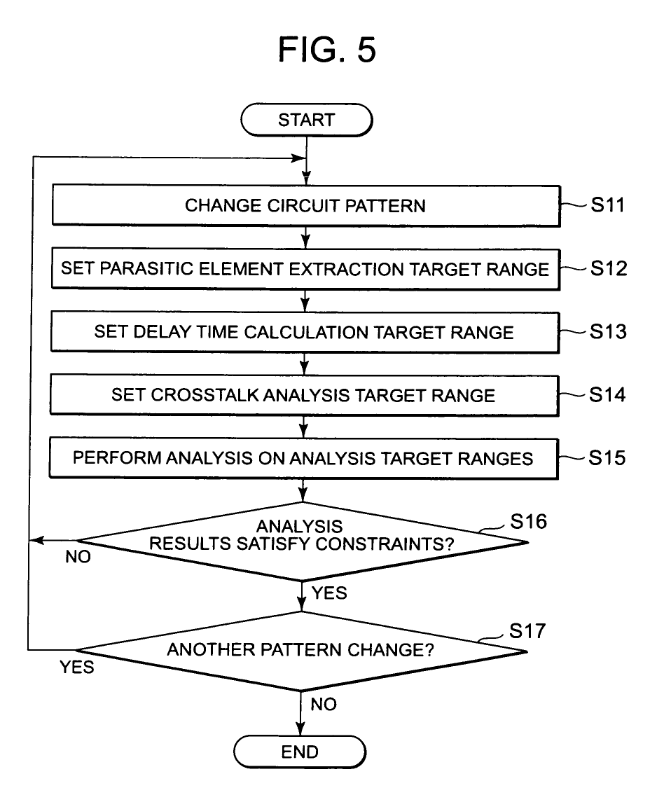

With reference to FIGS. 5 to 10, operations of the circuit analyzer 10 according to this embodiment of the present invention will be described.

Firstly, prior to a layout change, the analysis range references 24 are set. As described above, each of the analysis range references 24 is set on the basis of the specification of the corresponding one of a program for performing parasitic element extraction (the parasitic element extraction tool 211), a program for performing delay time calculation (the delay time analysis tool 212) and a program for performing a crosstalk analysis (the crosstalk analysis tool 213).

As the extraction range reference 41, a distance by which the layout change affects a delay time or crosstalk is preferably set. For example, the distance (the number of pitches) on the same layer as the reference point and the numbers of layers immediately above the layer including the reference point and of layers immediately below the layer are set as the extraction range reference 41. In this embodiment, the range of six pitches from a point indicated by the reference point in the same layer and the range of two layers immediately above and two layers immediately below the reference point are set as the extraction range reference 41.

In the calculation of the analysis target range 300, information on parasitic elements sandwiching each delay calculation target net as well as input waveform blunting of the driver cell of each delay calculation target net need to be taken into account, in general. The delay time of a re-extracted net is affected by the driver cell and the receiver cell connected to the net, the net connected to the output side of the receiver cell as well as the receiver cell of the net. For this reason, as the calculation range reference 42, the number of driver cells connected to the input side of the net set as the reference element and the number of receiver cells connected to the output side thereof are set. In this embodiment, one driver cell connected to the input side of the reference element and two receiver cells connected to the output side of the reference element are set as the calculation range reference 42.

In the crosstalk analysis, the influence of crosstalk can be accurately tested by testing the timing at which the in-phase or anti-phase net signals concurrently operate. Thus, to test crosstalk, timings (operation times) at which the net signals operate from 0 to 1 or from 1 to 0 need to be taken into account. Accordingly, as the test range reference 43, circuit portions having the same operation time as the reference circuit portion, for example, a region which is located between two latches or flip-flops and includes the reference circuit portion, are set.

Moreover, the circuit analyzer 10 stores the delay time constraint 80 and the crosstalk constraint 90, which are determined and created beforehand at the time of circuit design and which serve as constraint data for signals.

FIG. 5 is a flowchart showing operations in layout change processing according to this embodiment. With reference to FIG. 5, the operations of the layout change processing according to this embodiment will be described in detail. Firstly, the layout tool 214 forms a layout of a design target circuit in a layout phase, and then record the layout as the layout information 22 in the storage device 13. Then, a timing analysis is performed on the design target circuit after the layout. In the first timing analysis, parasitic element extraction, delay time analysis and a crosstalk analysis are performed on the entire design target circuit as in the conventional methods, to judge whether the delay time constraint 80 and the crosstalk constraint 90 are satisfied.

If the delay time does not satisfy the delay time constraint 80, or the crosstalk does not satisfy the crosstalk constraint 90, the circuit pattern (layout information 22) is changed (Step S11). In Step S11, after changing the cell arrangement and the positions of the circuit patterns, the layout tool 214 updates the layout information 22 on the basis of the changed coordinate data, and then creates the layout change information 30 as information for specifying the changed portion.

After the layout change, the parasitic element extraction tool 211 sets the parasitic element (parasitic parameter) extraction target range 100 (Step S12). In Step S12, the parasitic element extraction tool 211 identifies the layout-changed portion by referring to the layout change information 30. Then, the parasitic element extraction tool 211 determines the extraction target range 100 on the basis of the extraction range reference 41 by using a point of the identified changed portion as the reference point.

With reference to FIG. 7, a concrete example of the extraction target range 100 thus set will be described. FIG. 7 is a schematic view of a layout showing an example of the layout information 22 updated by the layout change and of the set extraction target range 100. In the following, description will be given on the assumption that an interconnection a1 has been modified (added or changed). The parasitic element extraction tool 211 refers to the layout change information 30, identifies the interconnection a1 as the changed portion, and then designates one point of the interconnection a1 as a reference point. On the basis of the parasitic extraction range reference 41, the parasitic element extraction tool 211 sets a range of six pitches from the reference point in the same layer as an extraction target range 100-1 and a range of two layers immediately above and two layers immediately below the reference point as an extraction target range 100-2, and thereby sets the region defined by the extraction target range 100-1 and the extraction target range 100-2 as the extraction target region 100.

The parasitic element extraction tool 211 outputs the layout information on the circuit portions in the set extraction target range 100, as the parasitic element re-extraction information 31. In the example shown in FIG. 7, the layout information on the interconnection a1 and interconnections a2 is outputted as the parasitic element re-extraction information 31, while layout information on circuit portions outside the extraction target range 100 (for example, layout information pieces on parasitic elements a3) is not extracted.

The range specified by the extraction range reference 41 and having the reference point as the center thereof is set as the parasitic element extraction target range 100. Thus, by using the extraction range reference 41 set in advance, the layout-changed interconnection a1 and the peripheral interconnections a2 are extracted as the parasitic element re-extraction information 31.

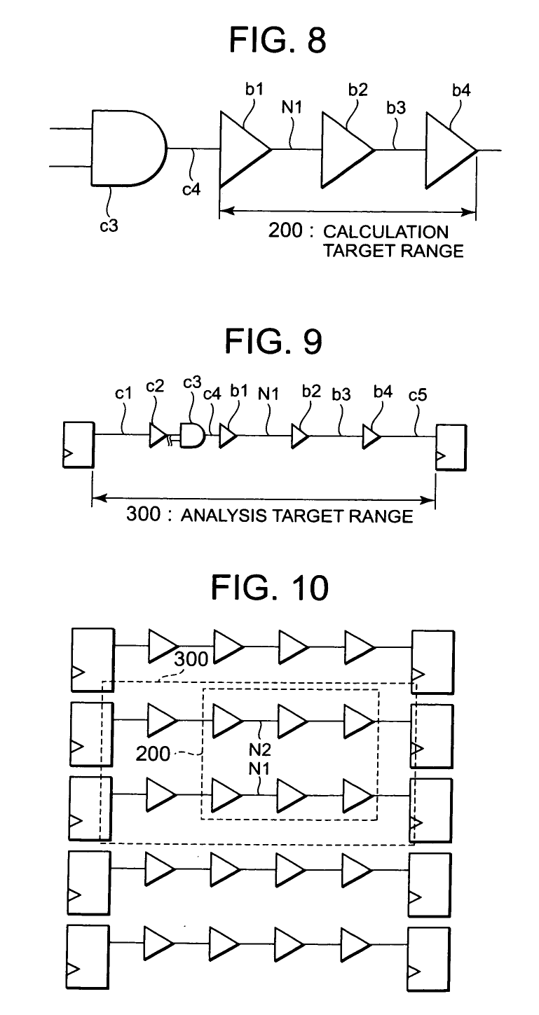

The delay time analysis tool 212 designates interconnections (nets) identified on the basis of the parasitic element re-extraction information 31 as reference elements, and then sets the delay time calculation target ranges 200 on the basis of the calculation range reference 42 (Step S13). In this example, each of a net N1 corresponding to the interconnection a1 and nets N2 corresponding to the interconnections a2 is designated as the reference element, and the calculation target ranges 200 respectively including the reference elements are set. FIG. 8 is a view showing an example of a part of the design target circuit including the net N1 corresponding to the interconnection a1 and the calculation target range 200 set by using the net N1 as the reference element.

The delay time analysis tool 212 designates the nets corresponding to the interconnections a1 and a2 set as the parasitic element re-extraction information 31 (here, the net N1 as an example), as the reference elements. Then, the delay time analysis tool 212 sets the ranges respectively including the designated reference elements, as the delay time calculation target ranges 200, on the calculation range reference 42. In this example, the range including one driver cell (an instance b1) connected to the interconnection (net N1) and two receiver cells (instances b2 and b4) connected to the output side of the interconnection (N1) is set as the delay time calculation target range 200.

The delay time analysis tool 212 outputs circuit connection information on the circuit portions in the calculation target range 200 (the net and instances), as the delay time re-calculation information 32. In the example shown in FIG. 8, the driver cell (instance b1), the interconnection (net N1), the receiver cell (instance b2), an interconnection (net b3) and the receiver cell (instance b4) are outputted as the delay time re-calculation information 32.

Here, the calculation target range 200 set by using each of the nets N2 as the reference element and the delay time re-calculation information 32 on the calculation target range 200 are also set as described above.

The crosstalk analysis tool 213 designates the circuit portions identified by the delay time re-calculation information 32, as reference circuit portions, and then sets the crosstalk analysis target range 300 on the basis of the test range reference 43 (Step S14). FIG. 9 is a view showing an example of a part of the design target circuit including the net N1 shown in FIG. 8 and the analysis target range 300 including the net N1 and set on the basis of the delay time re-calculation information 32. As shown in FIG. 9, the crosstalk analysis tool 213 refers to the delay time re-calculation information 32, and thereby designates the instances b1, b2 and b4 connected to the net N1 as well as the nets N1 and b3, as the reference circuit portions. Then, the crosstalk analysis tool 213 sets the range including the reference circuit portions and sandwiched between two flip-flops, as the analysis target range 300.

The crosstalk analysis tool 213 outputs circuit connection information (nets and instances) on the combinational circuit portions in the analysis target range 300, as the crosstalk re-analysis information 33. In the example shown in FIG. 9, instances b1, b2, b4, c2 and c3 as well as nets b3, c1, c4, c5 and N1 are outputted as the crosstalk re-analysis information 33.

Here, the analysis target range 300 set by using each of the interconnections a2 (nets N2) and the crosstalk re-analysis information 33 on the analysis target range 300 are also set as described above.

Thus, the circuit analyzer 10 according to this embodiment of the present invention performs a timing analysis on the limited analysis target ranges by taking account of the peripheral interconnections of the layout-changed interconnection. FIG. 10 is a view showing an example of the circuit target range 200 and the analysis target range 300 set by the circuit analyzer 10. When the net corresponding to the layout-changed interconnection a1 is the net N1 and the net corresponding to the peripheral interconnection a2 extracted by the parasitic element extraction tool 211 is the net N2, the delay time calculation target range 200 and the crosstalk analysis target range 300 are set as shown in FIG. 10. Specifically, as described above, the nets N1 and N2 are set as the reference elements, and the range including one driver cell connected to the net N1, two receiver cells from the net N1, one driver cell connected to the net N2 and two receiver cells from the net N2 is set as the calculation target region 200. Moreover, a range between two flip-flops (latches) including the circuit portions in the calculation target range 200 is set as the analysis target range 300.

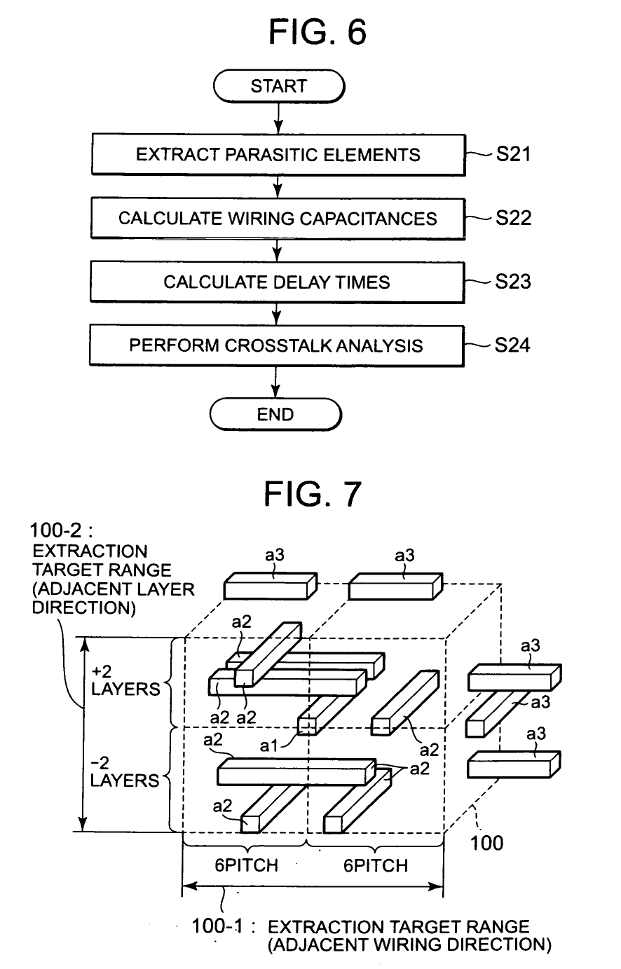

The circuit analyzer 10 performs a timing analysis on the analysis target ranges set in Steps S12 to S14 (Step S15). With reference to FIGS. 6 to 10, operations in the timing analysis in Step S15 will be described in detail.

FIG. 6 is a flowchart showing the details of the operations in the timing analysis processing performed in a layout change. As shown in FIG. 6, the parasitic element extraction tool 211 extracts parasitic elements in the extraction target range 100 set in Step S12 (Step S21). In the example shown in FIG. 7, the parasitic element extraction tool 211 extracts the interconnections a1 and a2 in the extraction target range 100 on the basis of the parasitic element re-extraction information 31. The parasitic element extraction tool 211 calculates the parasitic parameters 50 of the extracted interconnections a1 and a2 (Step S22). In Step S22, the wiring capacitances (coupling capacitances) are preferably calculated by approximate calculation by taking account of interconnections in the extraction target range 100.

The delay time analysis tool 212 calculates the delay times 60 of the interconnections included in the parasitic element re-extraction information 31, i.e., the interconnections set as the reference elements (Step S23). In this example, the delay times 60 of the nets N1 and N2 respectively corresponding to the interconnections a1 and a2 are calculated. The delay time analysis tool 212 calculates the delay times 60 on the basis of the circuit portions (instances and nets) in the set calculation target ranges 200 respectively having the layout-changed net N1 and the net N2 as the centers. Here, the delay time analysis tool 212 calculates the delay times 60 by using the wiring capacitances 50 calculated in Step S22. Thus, in this embodiment, the delay times 60 can be calculated by taking account of the peripheral parasitic elements a2 affected by the layout-changed interconnection a1.

The crosstalk analysis tool 213 tests crosstalk only on the circuit portions in each of the set analysis target ranges 300, by using the corresponding crosstalk re-analysis information 33 (Step S24). The circuit portions included in the crosstalk re-analysis information 33 only include circuit elements operating at the same timing as the corresponding one of the nets N1 and N2 corresponding to the interconnections extracted by the parasitic element extraction. This makes it possible for the crosstalk analysis tool 213 to test crosstalk only on the circuit portions operating at the same timing as the net N1 and the circuit portions operating at the same timing as the net N2. For example, crosstalk of the combinational circuit portions between two flip-flops (or latches) including the layout-changed net N1 and crosstalk of the combinational circuit portions between two flip-flops (or latches) including the net N2 are tested. Here, the crosstalk analysis tool 213 calculates crosstalk by using the corresponding wiring capacitance 50 calculated in Step S22 and the corresponding delay time 60 calculated in Step S23. Thus, in this embodiment, crosstalk can be tested by taking account of the peripheral interconnections a2 affecting the wring capacitance of the layout-changed interconnection a1 and also the circuit elements affecting the delay times of the layout-changed net N1 and the peripheral net N2.

As shown in FIG. 5, the layout tool 214 judges whether the delay times 60 and the crosstalk analysis results 70 obtained in Step S15 satisfy the constraints (the delay time constraint 80 and the crosstalk constraint 90) (Step S16). When the analysis results do not satisfy the constraints set in advance (No in Step S16), or when the analysis results satisfy the constraints and another pattern change is required (Yes in Step S16 and Yes in Step S17), the layout tool 214 performs a layout change again in Step S11. Then, in accordance with the layout change, the layout information 22 and the layout change information 30 are updated. Thereafter, a timing analysis from Steps S12 to S15 as described above is performed.

When the analysis results satisfy the constraints and no more pattern change is required (Yes in Step S16 and No in Step S17), the circuit analyzer 10 terminates the layout change processing.

The above described layout change processing and timing analysis processing are repeatedly performed until the timing analysis results obtained in Step S15 satisfy the constraints, and each time the process is repeated, the layout information 22 and the layout change information 30 are updated. When the layout change processing is completed, a semiconductor integrated circuit manufacturing apparatus (not illustrated) creates a mask by using the latest layout information 22 updated by the layout change, and then manufactures semiconductor integrated circuits by using the mask.

In this embodiment, the wiring capacitances 50 are calculated by taking account of parasitic elements in a peripheral region of the layout-changed parasitic element. With this configuration, the circuit analyzer 10 according to this embodiment of the present invention can accurately obtain wiring capacitances having changed due to the layout change. In addition, since the delay times and the crosstalk amounts are determined on the basis of the coupling capacitances (wiring capacitances) between the adjacent or crossing interconnections, the circuit analyzer 10 according to this embodiment can obtain accurate delay times and crosstalk.

In this embodiment, parasitic elements in the peripheral region of the layout-changed parasitic element are also extracted, and the delay time calculation target circuit models and the crosstalk analysis target circuit models are determined on the basis of the parasitic elements. The delay time and crosstalk analysis accuracies depend on the accuracies of circuit models determined on the basis of the parasitic elements extracted by the parasitic element extraction tool. Accordingly, the circuit analyzer 10 according to this embodiment can perform highly accurate delay time analyses and crosstalk analyses.

The analysis tools generally perform approximate calculation on a limited calculation target range so as to increase calculation speed while maintaining the equivalent analysis accuracy to that obtained in a full-chip analysis. The analysis range references 24 (the extraction range reference 41, the calculation range reference 42 and the test range reference 43) according to this embodiment are set in accordance with the analysis accuracies (approximate calculation capabilities) of the analysis tools, respectively. With this configuration, the circuit analyzer 10 according to this embodiment is capable of shortening calculation time while obtaining the wiring capacitances 50, the delay times 60 and the crosstalk analysis results 70 as accurate as those obtained in a full-chip analysis.

Hereinabove, the embodiment of the present invention has been described in detail. However, the concrete configuration of the present invention is not limited to the above-described embodiment, and configurations with modifications within the scope of the present invention are also included in the present invention.

What is claimed is:

1. A circuit analyzer for a design target circuit after a layout change, the circuit analyzer comprising:
a storage device in which an extraction range reference is set;
an extraction range setting unit which sets the extraction range reference including a layout-changed portion, as a parasitic element extraction target range; and
a timing analysis unit which performs a timing analysis by using, as an analysis target, a predetermined range including a parasitic element extracted from the extraction target range, wherein
the timing analysis unit updates, on the basis of a result of the timing analysis, a timing analysis result of the design target circuit after the layout change, the timing analysis result recorded in the storage device.

2. The circuit analyzer according to claim 1, further comprising a calculation range setting unit, wherein
a delay time calculation range reference is further set in the storage device,
the calculation range setting unit sets the delay time calculation range reference including the parasitic element extracted from the extraction target range, as a calculation target range, and
the timing analysis unit includes a delay time calculation unit which calculates a delay time in the calculation target range.

3. The circuit analyzer according to claim 2, further comprising an analysis range setting unit, wherein
a crosstalk analysis range reference is further set in the storage device,
the analysis range setting unit sets the crosstalk analysis range reference including the calculation target range, as an analysis target range, and
the timing analysis unit further includes a crosstalk analysis unit which analyses crosstalk in the analysis target range by using the delay time.

4. The circuit analyzer according to claim 3, wherein the analysis target range is a range defining a portion of the circuit operating at the same operation timing as a portion of the circuit in the calculation target range.

5. The circuit analyzer according to claim 1, wherein the extraction range reference is a range reference set on the basis of an analysis accuracy of the timing analysis unit.

6. The circuit analyzer according to claim 2, wherein the delay time calculation range reference is a range reference set on the basis of an analysis accuracy of the delay time calculation unit.

7. The circuit analyzer according to claim 3, wherein the crosstalk analysis range reference is a range reference set on the basis of an analysis accuracy of the crosstalk analysis unit.

8. The circuit analyzer according to 1, further comprising a layout change unit which performs a layout change on the design target circuit on the basis of the result of the timing analysis, wherein
the timing analysis unit judges whether the updated timing analysis result satisfies a constraint set in the storage device; and
the layout change unit performs a layout change on the design target circuit on the basis of a result of the judgment.
